(19) United States
(12) Patent Application Publication
(10) Pub. No.: US 2016/0117433 A1
(43) Pub. Date: Apr. 28, 2016

(54) INTEGRATED CIRCUIT TIMING VARIABILITY REDUCTION

(71) Applicant: GLOBALFOUNDRIES INC., Grand Cayman (KY)

(72) Inventors: Eric A. Foreman, Fairfax, VT (US); Chaitanya Kompalli, Bangalore (IN); Sudeep Mandal, Bangalore (IN); Sebastian T. Ventrone, South Burlington, VT (US)

(21) Appl. No.: 14/525,320

(22) Filed: Oct. 28, 2014

(51) Int. Cl. G06F 17/50

(52) U.S. Cl. CPC G06F 17/5081

(57) ABSTRACT

As disclosed herein, a method, executed by a computer, for integrated circuit timing variability reduction includes loading a netlist that corresponds to a chip design, where the chip design includes one or more circuits and a plurality of post-fill features, traversing a portion of the netlist corresponding to a circuit, determining a post-fill environment for the circuit from a plurality of post-fill features, and modeling a timing variance for the circuit based on the post-fill environment. The method may also include changing one or more post-fill features to achieve a targeted delay. The method may include generating a report of circuit timing and timing variances. One or more circuits can be concurrently traversed. The timing variance can be modeled with the use of a scaling factor for a standard timing variance. A computer system and computer program product corresponding to the method are also disclosed herein.

### BACKGROUND OF THE INVENTION

The present invention relates generally to the field of computer chip design, and more particularly to post-fill design optimization.

Post-fill design is an important step in computer chip fabrication. Post-fill design is the process of patterning filler structures on a chip to standardize cell and chip density, improving chip yield and performance. Post-fill is typically added to the chip during finishing stages, to create a uniform thickness across the chip. To accommodate the differing circuit designs, filler structures are widely versatile. Among the many versatile characteristics are geometry, material, and method of application.

### SUMMARY

As disclosed herein, a method, executed by a computer, for integrated circuit timing variability reduction includes loading a netlist that corresponds to a chip design, where the chip design includes one or more circuits and a plurality of post-fill features, traversing a portion of the netlist corresponding to a circuit, determining a post-fill environment for the circuit from a plurality of post-fill features, and modeling a timing variance for the circuit based on the post-fill environment. The method may also include changing one or more post-fill features to achieve a targeted delay. The method may include generating a report of circuit timing and timing variances. One or more circuits can be concurrently traversed. The timing variance can be modeled with the use of a scaling factor for a standard timing variance. The method provides post-fill aware chip design and a means to minimize on-chip timing and timing variance caused by the post-fill environment. A computer system and computer program product corresponding to the method are also disclosed herein.

### BRIEF DESCRIPTION OF THE DRAWINGS

FIG. 1 is a functional block diagram of one embodiment of a chip design process in which at least some of the embodiments disclosed herein may be deployed;

FIG. 2 is a flowchart depicting one embodiment of a timing analysis method that incorporates post-fill variance;

FIG. 3 is a flowchart depicting one embodiment of a post-fill optimization method;

FIGS. 4a and 4b are floor plan diagrams depicting a chip cell before and after post-fill optimization; and

FIG. 5 is a block diagram depicting one example of a computing apparatus (i.e., computer) suitable for executing the methods disclosed herein.

### DETAILED DESCRIPTION

As computer chips decrease in size, and the dependence on quick circuit timing increases, integrated circuit designers must consider more factors during chip design. While timing delay caused by post-fill structures has been known in the art for a while, there has not been a recognized need to minimize the effects of post-fill structures.

While timing problems are recognized with post-fill structures, current chip design techniques do not attempt to optimize the post-fill environment. Instead, current chip design practices account for delay caused by the post-fill structures by factoring in a worst-case scenario. For example, a standard post-fill timing variance is added to the calculated circuit delay to obtain a recognized chip timing. However, with the methods disclosed herein, the effects of post-fill structures on chip timing can be more accurately accounted for. Further, by selectively choosing a post-fill environment, the delay caused by the post-fill environment can be minimized.

The disclosed embodiments describe the statistical methodology and timing flow for post-fill structures. One disclosed embodiment reduces pessimism in pre-accounted for post-fill delay variation. Another disclosed embodiment alters the post-fill environment to reduce statistical performance variation. More specifically, the disclosed embodiments use an iterative method to account for cumulative performance sensitivity across a chip.

The disclosed methods more accurately account for variances in the timing caused by post-fill structures and minimize the delay and delay variance caused by the post-fill environment. Although specific embodiments are described here, the invention is not limited to these embodiments.

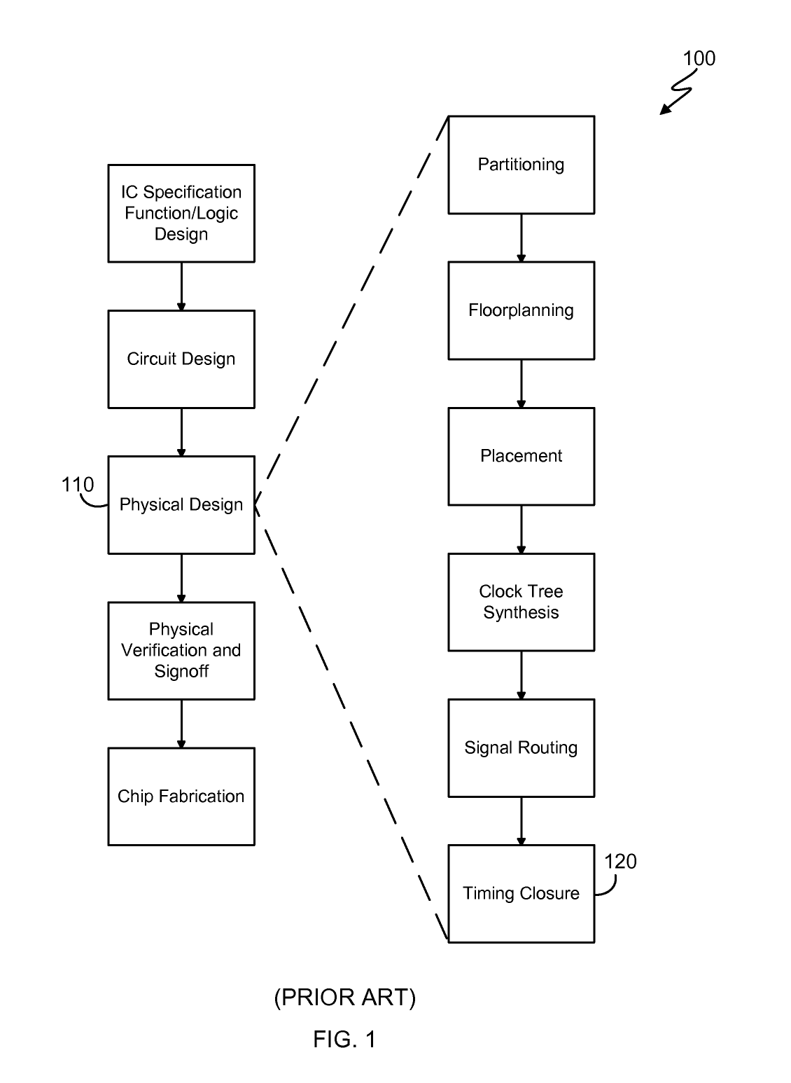

FIG. 1 is a functional block diagram of one embodiment of a chip design process 100 in which at least some of the embodiments disclosed herein may be deployed. Chip design process 100 depicts, broadly, each step in the integrated circuit manufacture process. At least one embodiment of the disclosed invention occurs in the physical design phase 110 of the chip design process 100. Physical design phase 110 can be completed with the aid of a computing apparatus, such as a workstation. In the depicted environment, a timing closure phase 120 is the final step in the physical design phase 110. Although the embodiments disclosed herein will be generally described as occurring during the timing closure phase 120 of the physical design phase 110, it is widely recognized in the art that post-fill design can be added at many stages of the chip design.

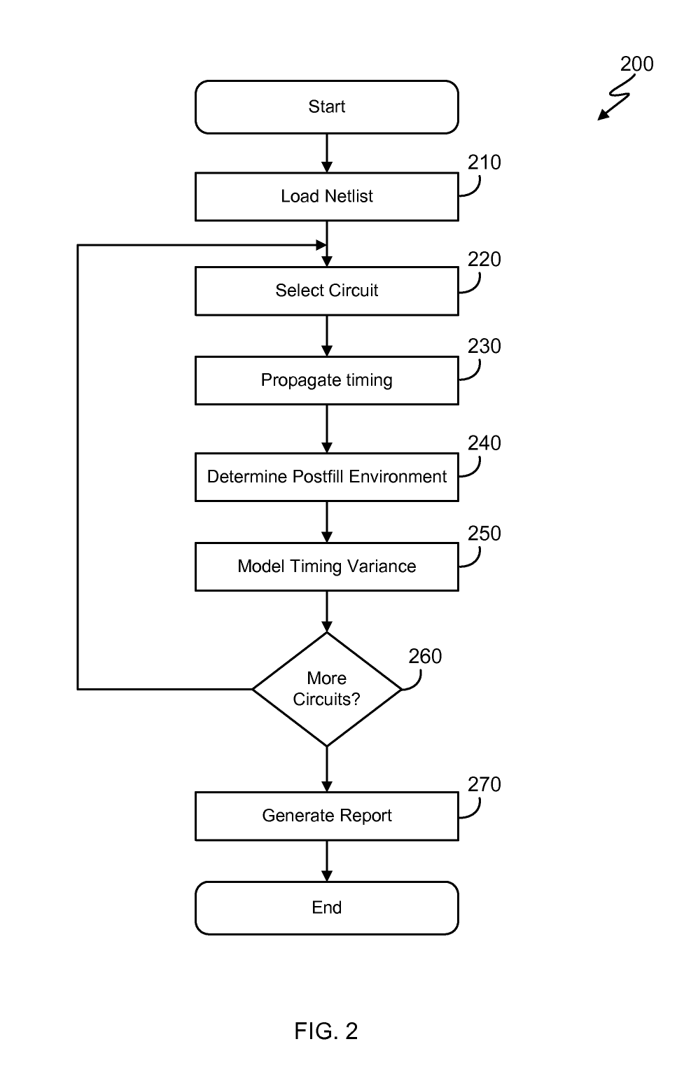

FIG. 2 is a flowchart depicting one embodiment of a timing analysis method 200 that incorporates post-fill variance. As depicted, the timing analysis method 200 includes loading (210) a netlist, selecting (220) a circuit, propagating (230) a timing for the selected circuit, determining (240) a post-fill environment, modeling (250) a timing variance for the post-fill environment, determining (260) whether additional circuits need to be processed, and generating (270) a report of the circuit timing and variances. The timing analysis method 200 enables designers of integrated circuits to more accurately identify the timing of a chip with a post-fill environment and determine which circuits need additional optimization.

The depicted method starts by loading (210) a netlist that includes information related to one or more circuits. The netlist describes the connectivity of an electrical design and related properties. The netlist may be created during the physical design phase 110.

Once the netlist is loaded, the method continues by selecting (220) a circuit, each circuit having a corresponding portion of the netlist. While the depicted embodiment teaches a method of selecting individual circuits, it is possible for the method to proceed concurrently through every circuit on the chip, or a subset of circuits. For each circuit that is selected, a timing for the circuit, without a post-fill environment, is determined by propagating (230) a timing for the portion of the netlist corresponding to the circuit.

The method continues by determining (240) a post-fill environment. The post-fill environment may include one or more post-fill structures. The post-fill environment, and therefore individual structures, can cause a delay (e.g., due to capacitance), which will increase the timing of the propagation delay. The timing variance may also be affected due to variance in the manufacturing process. Post-fill structures can have many different properties; the different properties can affect the delay caused by the post-fill environment.

Properties of a post-fill structure can vary due to manufacturing variations. Standard post-fill variations can include changes in threshold voltage of the post-fill structure and adjacent cell, which are related to the manufacturing variations. Further, the length and material (e.g. polysilicon or metal) of the gate used in the post-fill structure can cause variations in width and shape of the structure. Specific post-fill structures can be chosen to aid in manufacturing processes, including, but not limited to, lithography, etching, and relevant process steps.

Once the post-fill environment is selected for a circuit, the delay caused by the post-fill environment is calculated and used in modeling (250) a timing variance. The timing variance is the representative of the difference between the fastest timing and slowest timing of a signal passing through the circuit. The timing model uses the chip timing, determined in the propagating (230) step, and the post-fill delay for the selected post-fill environment to determine a chip timing variance.

Analysis of the circuit timing and timing variance is done through the modeling (250) of the post-fill environment. In one embodiment, timing variance is calculated in terms of sensitivity. One equation that can be used to determine the sensitivity is

$${G}_{j} = {\sum }_{N} \frac{\partial {D}_{i}}{\partial {V}_{t}} . \qquad ( 1 )$$

Where, Gⱼ may be used to represent the total delay sensitivity due to post-fill for the circuit. Additionally, in the equation,

$$\frac{\partial {D}_{i}}{\partial {V}_{t}} \qquad ( 2 )$$

may be used to represent the delay sensitivity due to a voltage threshold device variation for a specific post-fill structure; where, Dᵢ is delay and Vₜ is the voltage threshold for a device. In equation 2, the delay variation changes according to device type; there are high-Vₜ devices and low-Vₜ devices. The high- and low-Vₜ devices are created to switch at different voltage thresholds and designed to trade-off switching speed with leakage; the different devices vary in size, which changes how the post-fill impacts the circuit.

In another embodiment, timing variance can be expressed in terms of total variability. The equation for the total variability is

$${H}_{j} = \sqrt{{\sum }_{N} {( \frac{\partial {D}_{i}}{\partial {V}_{t}} )}^{2}} . \qquad ( 3 )$$

The total variability is the root sum of square of the sensitivity. One skilled in the art would recognize that sensitivity and variability are functionally interchangeable.

In yet another embodiment, the timing variance can be in terms of the sensitivity of line to line capacitance. The equation for this embodiment is

$${G}_{Line to line} = \sqrt{{\sum }_{i = 1}^{N} \frac{\partial {C}_{Line to line}}{{q}_{ai}}} .$$

The C_{Line to line} is the capacitance and qₐᵢ is the charge variation or cap variation due to the post-fill.

Modeling (250) may include the use of scale factors to represent the chip timing variance. Scale factors are based on actual delays observed by similar post-fill environments in test chips—in general, scale factors range from 0 to 1 in value. In an embodiment using scale factors, the scale factors are compiled in a table that can be used in the modeling step of the method. To implement the use of scale factors, the modeling (250) step would apply the scale factor to the post-fill delay to represent actual timing variance for a specific circuit and post-fill environment combination.

The method continues by determining (260) whether additional circuits need to be analyzed. As discussed above, a netlist may contain information pertaining to one or more circuits; therefore, the method can be set to run individual circuits, a group of circuits, or all of the circuits on the netlist. By running the analysis on multiple circuits, the method may determine the timing and delay across a chip containing multiple circuits. When more than one circuit needs to be analyzed, the method loops back to selecting (220) a circuit, until each circuit specified for analysis has been analyzed. Once the method has analyzed each circuit specified for analysis, the method finishes by generating (270) a report of the timing variances.

Generating (270) a report may include saving a file, sending an output to a connected printer, or any other means of displaying results. The report may include timing characteristics of a circuit. Timing characteristics can include timing variance and delay. Further, the report can incorporate timing metrics, for example, setup, hold slacks, dependent parameters such as clock skew, and other parameters that are derived from arrival times.

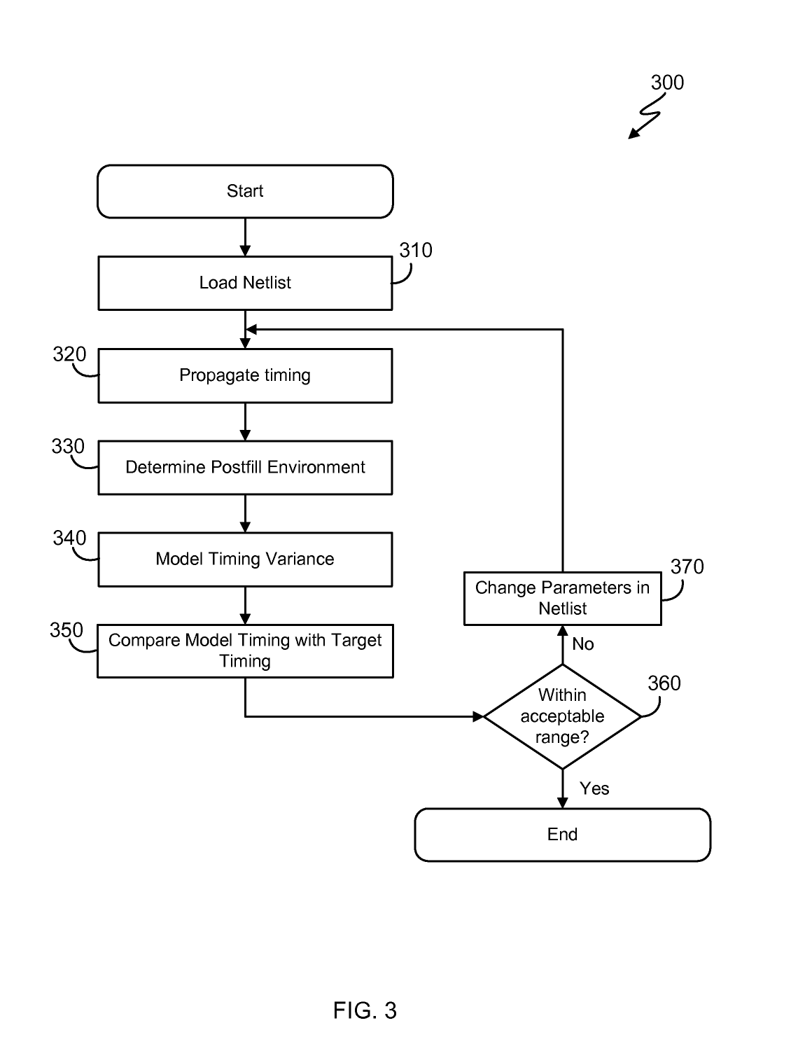

FIG. 3 is a flowchart depicting one embodiment of a post-fill optimization method 300. As depicted, the post-fill optimization method 300 includes loading (310) a netlist, propagating (320) a timing for a chosen circuit, determining (330) a post-fill environment, modeling (340) a timing delay for the post-fill environment, comparing (350) the modeled timing delay with a target timing, determining (360) whether the model timing delay is within an acceptable range, and changing (370) parameters in the netlist. The post-fill optimization method 300 enables an integrated circuit designer to selectively place post-fill structures on a chip, such that the post-fill has a minimal effect on chip timing.

The post-fill optimization method 300 begins by loading (310) a netlist. The netlist may contain all of the electrical connectivity design and properties. The netlist contains data corresponding to an entire chip; however, post-fill optimization method 300 can be performed on a single circuit or subset of circuits on a chip.

By propagating (320) a timing for a chosen circuit, a minimum and maximum timing for the circuit, without the effects of a post-fill environment, can be obtained. Similar to the post-fill analysis method 200 above, post-fill optimization 300 continues by determining (330) a post-fill environment.

The delay caused by the post-fill structures is determined by modeling (340) a timing delay for the circuit with a post-fill environment. Next, the method analyzes the model by comparing (350) the modeled timing delay with the pre-post-fill timing.

Next, the method decides whether action needs to be taken on the post-fill environment by determining (360) whether the model timing delay is within an acceptable range. The method compares the model timing delay with a target timing. The target timing is the maximum time for input to pass through the circuit. As electronics are designed to work faster, the target timing becomes more critical. If an acceptable delay range is not met, the method will attempt to modify the delay by changing (370) various parameters.

The method can make a number of changes to the netlist to optimize the timing of a cell. The parameters that can be changed include, but are not limited to, individual post-fill structures, the circuit layout, etc. Post-fill structures can have properties that affect the timing; the properties can include threshold voltage, structure size, cell gate type, etc. However, some post-fill structures are chosen to aid or perform manufacturing functionalities. When the post-fill structure is chosen for a specific functionality, the method can take the special function into account and optimize around a particular cell. The post-fill optimization method 300 will repeat until an acceptable timing delay is obtained.

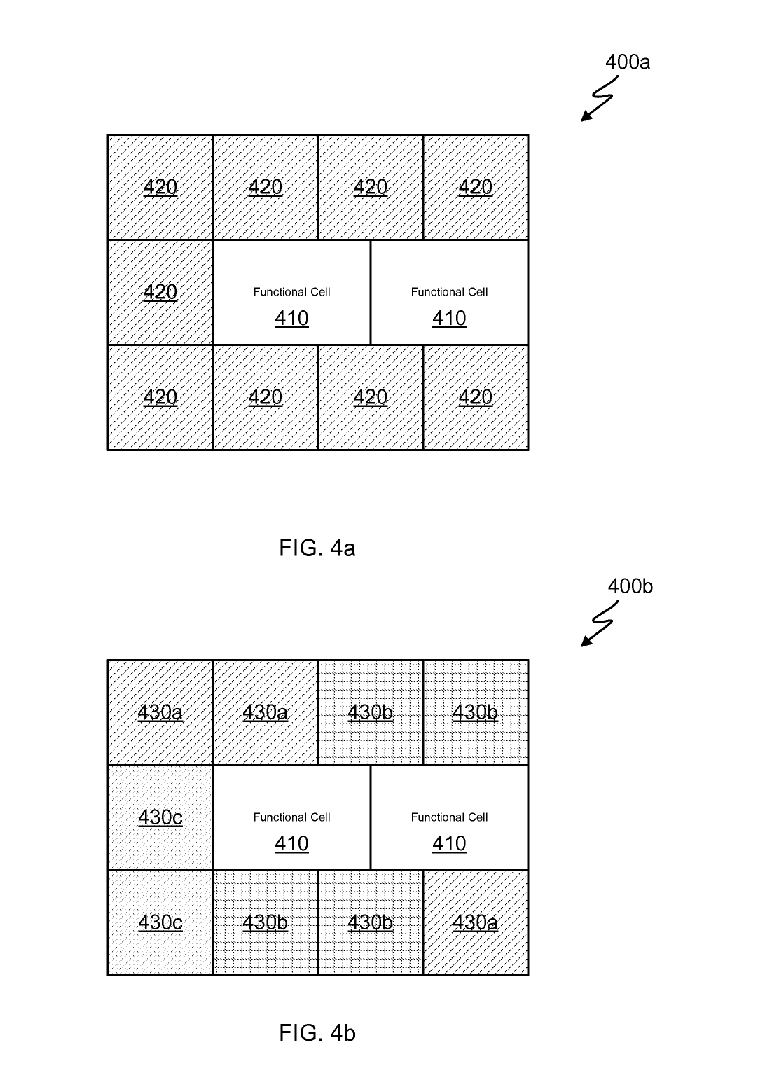

FIGS. 4a and 4b are floor plan diagrams depicting an example of a chip cell before and after post-fill optimization. FIG. 4a represents one embodiment of standard post-fill chip 400a. Standard post-fill chip 400a includes functional cells 410 and standard post-fill cells 420. FIG. 4b represents one embodiment of optimized post-fill chip 400b. Optimized post-fill chip 400b includes functional cells 410 and optimized post-fill cells 430a, 430b, and 430c. Together, standard post-fill chip 400a and optimized post-fill chip 400b show how post-fill optimization method 300 selectively places post-fill features.

Functional cells 410 can include the individual circuits analyzed by the post-fill analysis method 200 and post-fill optimization method 300. The functional cell is the active component on the integrated circuit. The functional cell may or may not be changed through use of the proposed methods. Therefore, it should be recognized that the post-fill analysis method 200 and post-fill optimization method 300 could include steps to change parameters of the active components of a functional cell.

Standard post-fill cells 420 are representative of how post-fill is applied without the use of the post-fill analysis method 200 and post-fill optimization method 300. As shown, one type of cell, often referred to as a dummy cell, would be placed everywhere post-fill is needed. Standard post-fill cells 420 contribute a timing delay and associated variance that is different for each cell type. While standard post-fill cells 420 may affect each functional cell 410 differently, based on the properties of functional cell 410, without the use of post-fill analysis method 200, the same worst-case variance is applied to each circuit to calculate a circuit timing. However, through the use of the post-fill analysis method 200, a more accurate circuit timing can be calculated by factoring in the delay variance caused by interactions between various functional cells 410 and standard post-fill cells 420.

Optimized post-fill cells 430a, 430b, and 430 are representative of post-fill cells placed on a chip as a result of the post-fill optimization method 300. Each optimized post-fill cell 430a, 430b, and 430c have unique voltage qualities. Through post-fill optimization method 300, post-fill cells 430a, 430b, and 430c can be selectively placed to minimize the timing delay caused by the interaction of functional cell 410 and optimized post-fill cells 430a, 430b, and 430c.

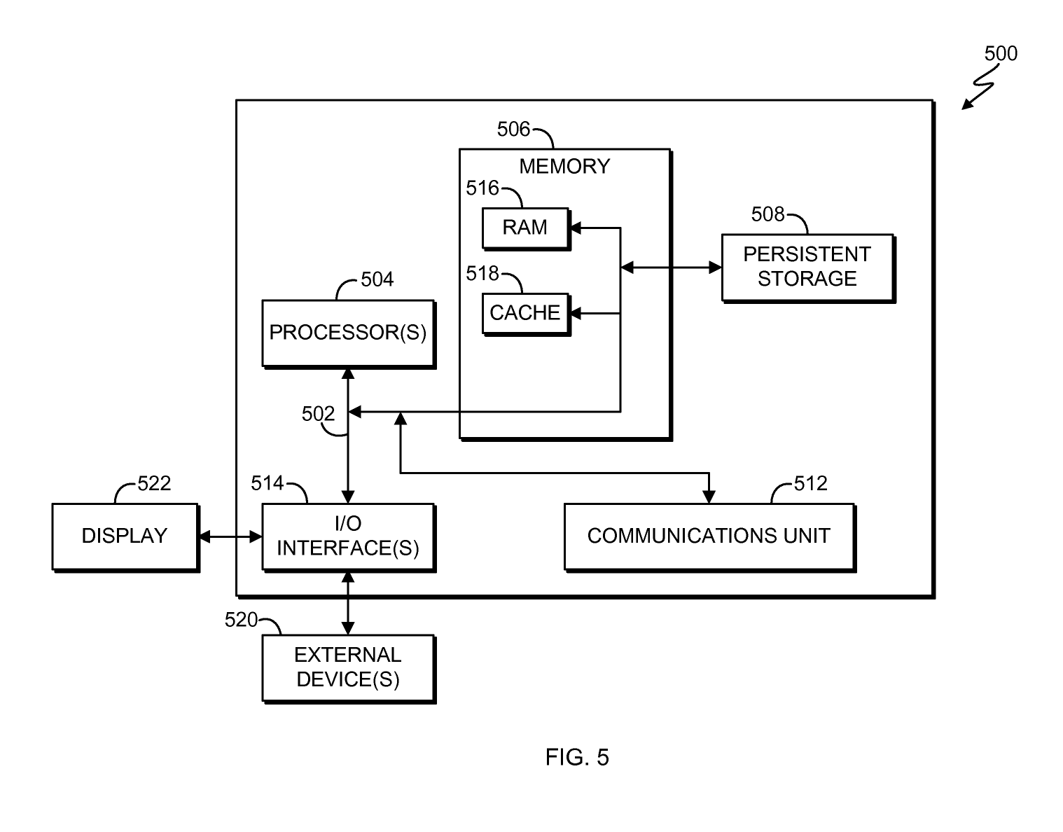

FIG. 5 is a block diagram depicting one example of a computing apparatus 500 (i.e., computer) suitable for executing the methods disclosed herein. The computer 500 may be used to complete one or more phases, including physical design phase 110, depicted in FIG. 1. It should be appreciated that FIG. 5 provides only an illustration of one embodiment and does not imply any limitations with regard to the environments in which different embodiments may be implemented. Many modifications to the depicted environment may be made.

As depicted, the computer 500 includes communications fabric 502, which provides communications between computer processor(s) 504, memory 506, persistent storage 508, communications unit 512, and input/output (I/O) interface(s) 514. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In the depicted embodiment, memory 506 includes random access memory (RAM) 516 and cache memory 518. In general, memory 506 can include any suitable volatile or non-volatile computer readable storage media.

One or more programs may be stored in persistent storage 508 for execution by one or more of the respective computer processors 504 via one or more memories of memory 506. The persistent storage 508 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 512, in these examples, provides for communications with other data processing systems or devices. In these examples, communications unit 512 includes one or more network interface cards. Communications unit 512 may provide communications through the use of either or both physical and wireless communications links.

I/O interface(s) 514 allows for input and output of data with other devices that may be connected to computer 500. For example, I/O interface 514 may provide a connection to external devices 520 such as a keyboard, keypad, a touch screen, and/or some other suitable input device. External devices 520 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 508 via I/O interface(s) 514. I/O interface(s) 514 also connect to a display 522. Display 522 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The embodiments disclosed herein include a system, a method, and/or a computer program product. The computer program product may include a computer readable storage medium (or media) having computer readable program instructions thereon for causing a processor to carry out the methods disclosed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method, executed by a computer, for integrated circuit timing variability reduction, the method comprising:
loading a netlist corresponding to a chip design, the chip design comprising one or more circuits and a plurality of post-fill features;
traversing a portion of the netlist corresponding to a circuit;
propagating a timing for the portion of the netlist, wherein the propagating includes determining a timing for the circuit without a post-fill environment;
determining a post-fill environment for the circuit from the plurality of post-fill features;
modeling a timing variance for the circuit based on the post-fill environment for the circuit,
wherein the modeling is based on the propagated timing and a post-fill delay for the determined post-fill environment; and
revising the chip design to reduce timing variability based on the modeling.

2. The method of claim 1, further comprising changing one or more post-fill features to achieve a targeted delay.

3. The method of claim 1, further comprising generating a report describing timing characteristics for the circuit.

4. The method of claim 1, wherein one or more circuits of the chip design are concurrently traversed.

5. The method of claim 1, wherein the timing variance is dependent on a circuit cell type and the post-fill environment for the circuit.

6. The method of claim 1, wherein modeling the timing variance comprises applying a scaling factor to a standard timing variance.

7. The method of claim 1, further comprising changing one or more parameters for the circuit to achieve a targeted delay.

8. A computer program product for conducting integrated circuit timing variability reduction, the computer program product comprising:
one or more computer readable storage media and program instructions stored on the one or more computer storage media, the program instructions comprising instructions to:
load a netlist corresponding to a chip design, the chip design comprising one or more circuits and a plurality of post-fill features;
traverse a portion of the netlist corresponding to a circuit;
propagate a timing for the portion of the netlist, wherein the propagating includes determining a timing for the circuit without a post-fill environment;
determine a post-fill environment for the circuit from the plurality of post-fill features; and
model a timing variance for a circuit based on the post-fill environment for the circuit,
wherein the modeling is based on the propagated timing and a post-fill delay for the determined post-fill environment; and
revise the chip design to reduce timing variability based on the modeling.

9. The computer program product of claim 8, wherein the instructions comprise instructions to change one or more post-fill features to achieve a targeted delay.

10. The computer program product of claim 8, wherein the instructions comprise instructions to generate a report describing timing characteristics for the circuit.

11. The computer program product of claim 8, wherein the instructions to traverse a portion of the netlist, traverse multiple circuits concurrently.

12. The computer program product of claim 8, wherein the instructions to model the timing variance comprise instructions to apply a scaling factor to a standard timing variance.

13. The computer program product of claim 8, wherein the instructions comprise instructions to change one or more parameters for the circuit to achieve a targeted delay.

14. the computer program product of claim 8, wherein the timing variance is dependent on a circuit cell type and the post-fill environment for the circuit.

15. A computer system for conducting integrated circuit timing variability reduction, the computer system comprising:
one or more computer processors;
one or more computer readable storage media;
program instructions stored on the computer readable storage media for execution by at least one of the computer processors, the program instructions comprising instructions to:
load a netlist corresponding to a chip design, the chip design comprising one or more circuits and a plurality of post-fill features;
traverse a portion of the netlist corresponding to a circuit;
propagate a timing for the portion of the netlist, wherein the propagating includes determining a timing for the circuit without a post-fill environment;
determine a post-fill environment for the circuit from the plurality of post-fill features; and
model a timing variance for the circuit based on the post-fill environment for the circuit,
wherein the modeling is based on the propagated timing and a post-fill delay for the determined post-fill environment; and
revise the chip design to reduce timing variability based on the modeling.

16. The computer program product of claim 15, wherein the instructions comprise instructions to change one or more post-fill features to achieve a targeted delay.

17. The computer program product of claim 15, wherein the instructions comprise instructions to generate a report describing timing characteristics for the circuit.

18. The computer program product of claim 15, wherein the instructions to traverse a portion of the netlist comprise instruction to traverse the entire netlist.

19. The computer program product of claim 17, wherein the instructions to model the timing variance comprise instruction to apply a scaling factor to a standard timing variance.

20. The computer program product of claim 17, wherein the instructions comprise instructions to change one or more parameters for the circuit to achieve a targeted delay.
